(19) United States
(12) Patent Application Publication
(10) Pub. No.: US 2004/0133551 A1
(43) Pub. Date: Jul. 8, 2004

(54) Method and system of data warehousing and building business intelligence using a data storage model

(75) Inventor: Daniel Eames Linstedt, Littleton, CO (US)

Correspondence Address: MICHAEL BEST & FRIEDRICH, LLP, 100 E WISCONSIN AVENUE, MILWAUKEE, WI, 53202, US

(73) Assignee: Core Integration Partners, Inc., Denver, CO

(21) Appl. No.: 10/737,426

(22) Filed: Dec. 16, 2003

Related U.S. Application Data
(62) Division of application No. 09/965,343, filed on Sep. 27, 2001.
(60) Provisional application No. 60/271,336, filed on Feb. 24, 2001.

(51) Int. Cl. G06F 7/00

(52) U.S. Cl. 707/1

(57) ABSTRACT

A data migration, data integration, data warehousing, and business intelligence system including a data storage model is provided that allows a business to effectively utilize its data to make business decisions. The system can be designed to include a number of data storage units including a data dock, a staging area, a data vault, a data mart, a data collection area, a metrics repository, and a metadata repository. Data received from a number of source systems moves through the data storage units and is processed along the way by a number of process areas including a profiling process area, a cleansing process area, a data loading process area, a business rules and integration process area, a propagation, aggregation and subject area breakout process area, and a business intelligence and decision support systems process area. Movement of the data is performed by metagates. The processed data is then received by corporate portals for use in making business decisions. The system may be implemented by an implementation team made up of members including a project manager, a business analyst, a system architect, a data modeler/data architect, a data migration expert, a DSS/OLAP expert, a data profiler/cleanser, and a trainer.

### CROSS REFERENCE TO RELATED APPLICATIONS

This patent application is a divisional application of U.S. application Ser. No. 09/965,343, filed on Sep. 27, 2001, which claims the benefit of U.S. Provisional Application No. 60/271,336, filed on Feb. 24, 2001.

### BACKGROUND OF THE INVENTION

The present invention relates to data warehousing and the use of data to manage the operation of a business entity. More particularly, the invention relates to a data migration, data integration, data warehousing, and business intelligence system.

Modern businesses collect massive amounts of data concerning business operations. This data includes an enormously wide variety of data such as product data, pricing data, store data, customer preferences data, and purchasing data to name but a few of the categories of data collected. Data may be collected from a variety of legacy computer systems, enterprise resource planning (“ERP”) systems, customer relationship management (“CRM”) systems, web sites, and other sources. To support efforts to store, process, and use this data in useful ways, most businesses have implemented one or more data warehouses, which are large databases structured in a way that supports business decision-making.

As businesses have sought to improve the performance, value, integration, and maintainability of their data warehouse systems, many have run into problems associated with one or more of the following: having too much data, having data of bad quality (out-of-date, duplicative, erroneous, etc.), poor system design and architecture, a lack of standards for storing and analyzing data, an inability to repeat prior implementation efforts, a lack of system reliability, and high cost.

### SUMMARY OF THE INVENTION

The inventor has discovered that many of the above problems can be reduced or eliminated by employing a set of standard practices and a well-designed, well-integrated matrix of data processing modules.

In one embodiment the invention provides a method of building business intelligence. The method includes receiving data from at least one source system of an enterprise, wherein the data is representative of business operations of the enterprise; delivering the data to a staging area via a first metagate, wherein the staging area focuses the data into a single area on a single relational database management system; delivering the data from the staging area to a data vault via a second metagate, wherein the data vault houses data from functional areas of the enterprise; delivering the data from the data vault to a data mart via a third metagate, wherein the data mart stores data for a single function of the functional areas of the enterprise; transferring data to at least one of a business intelligence and decision support systems module, a corporate portal module, and at least one of the at least one source system of the enterprise; collecting metrics in a metrics repository; and collecting metadata in a metadata repository.

In another embodiment the invention provides a data migration, data integration, data warehousing, and business intelligence system. The system includes a profiling process area; a cleansing process area; a data loading process area; a business rules and integration process area; a propagation, aggregation, and subject area breakout process area; and a business intelligence and decision support systems process area.

In another embodiment the invention provides a data migration, data integration, data warehousing, and business intelligence system. The system includes a staging area; a data vault; a data mart; a metrics repository; and a metadata repository.

In another embodiment the invention provides a method of implementing a data migration, data integration, data warehousing, and business intelligence system. The method includes providing an implementation team, wherein the implementation team includes a project manager whose function is to manage the implementation of the data migration, data integration, data warehousing, and business intelligence system at client sites; a business analyst whose function is to interface with end-users, collecting, consolidating, organizing, and prioritizing business needs of the end-users; a systems architect whose function is to provide a blueprint for the hardware, software, and interfaces that defines the flow of data between components of the data migration, data integration, data warehousing, and business intelligence system; a data modeler/data architect whose function is to model and document source systems and business requirements of the end-users; a data migration expert whose function is to determine and develop the best solution to migrate and integrate data from the various sources systems; and a DSS/OLAP expert whose function is to determine and develop the best reporting solution or DSS based on end-user business requirements and to implement any OLAP tools selected for use in the data migration, data integration, data warehousing, and business intelligence system. The method also includes allowing the members of the implementation team to perform the function they are trained to perform in a specialized manner; providing mentoring, cross-training, and support through the course of implementing the data migration, data integration, data warehousing, and business intelligence system; and leaving the end-users with documentation and deliverables for maintaining and expanding the data migration, data integration, data warehousing, and business intelligence system.

In another embodiment the invention provides a data storage device for housing data from functional areas of an enterprise. The data storage device includes at least two hubs, wherein each of the at least two hubs includes a primary key, a stamp indicating the loading time of the primary key in the hub, and a record source indicating the source of the primary key; at least two satellites, wherein each of the at least two satellites is coupled to at least one of the at least two hubs in a parent-child relationship, further wherein each satellite includes a stamp indicating the loading time of data in the satellite and a business function; a link to provide a one-to-many relationship between two of the at least two hubs; and a detail table coupled to at least one of the at least two hubs, wherein the detail table includes attributes of the data from the functional areas of the enterprise.

These features as well as other advantages of the invention will become apparent upon consideration of the following detailed description and accompanying drawings of the embodiments of the invention described below.

### BRIEF DESCRIPTION OF DRAWINGS

FIG. 1 is a diagram of a system of one embodiment of the invention.

FIG. 2 is a flow diagram illustrating process areas in a system of one embodiment of the invention.

FIGS. 3A-3D illustrates a diagram defining the architecture of a data storage mechanism used in one embodiment of the invention.

FIG. 4 is a diagram illustrating members of an implementation team

### DETAILED DESCRIPTION

Before embodiments of the invention are explained, it is to be understood that the invention is not limited in its application to the details of the construction and the arrangements of the components set forth in the following description or illustrated in the drawings. The invention is capable of other embodiments and of being practiced or being carried out in various ways. Also, it is to be understood that the phraseology and terminology used herein is for the purpose of description and should not be regarded as limiting.

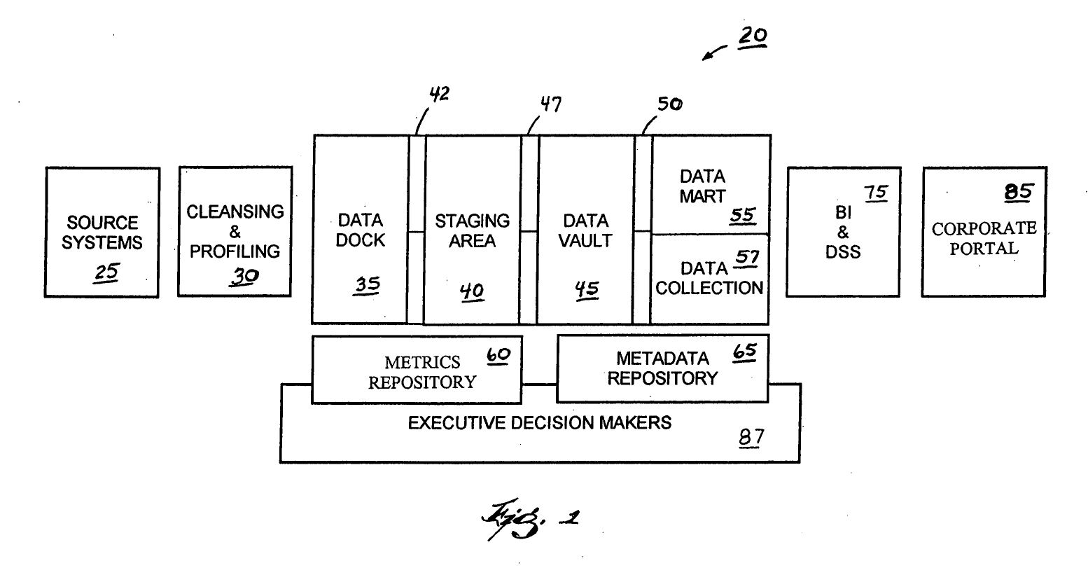

FIG. 1 illustrates a system 20 of one embodiment of the invention along with other systems and components that interact with the system 20. The system 20 implements a flexible methodology for building successful data solutions. The system 20 provides a formalized blueprint (i.e., build process) that combines a plug-and-play implementation architecture with industry practices and standards. The architecture is a flexible foundation from which to build enterprise-wide data solutions. A data solution for an enterprise can include all available modules of the system 20, or the enterprise can pick and choose modules of the system 20 to fit its current needs. The flexible foundation allows for future growth using the plug-and-play implementation, so as the enterprise's needs grow, the architecture and methodology also advance.

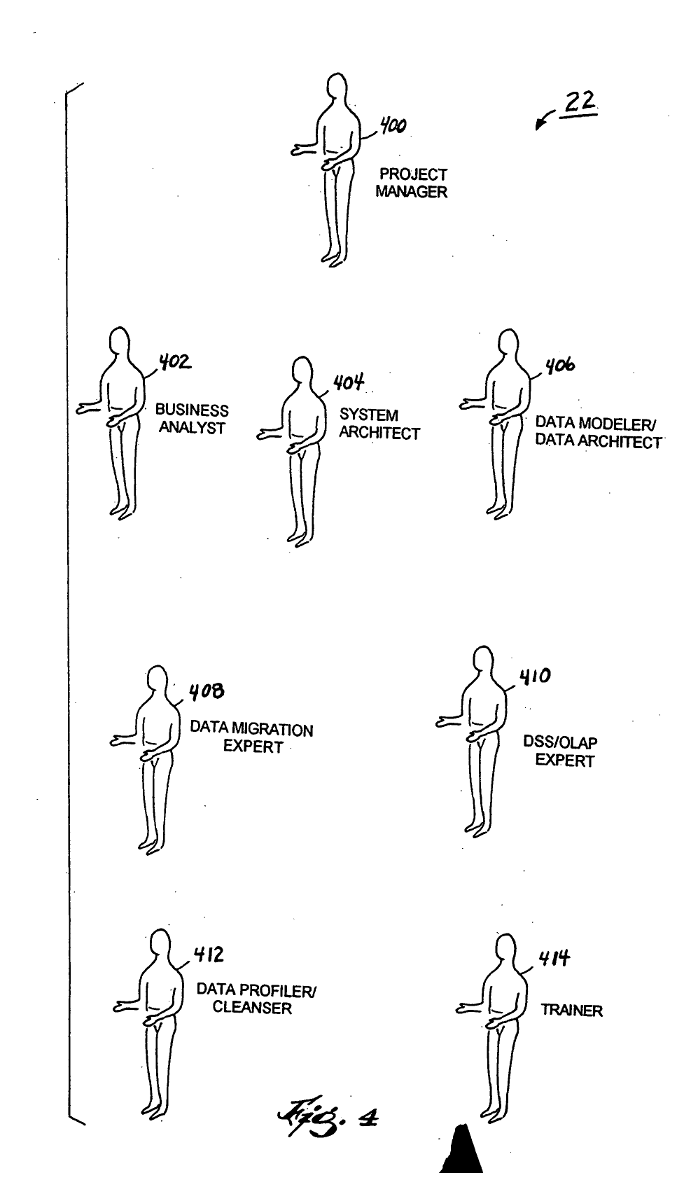

In one embodiment, the invention incorporates activities carried out by a team of individuals, hereinafter called the implementation team 22 (see FIG. 4). The implementation team 22 implements process-centered techniques and an embodiment of the system 20 to provide data solutions to an organization.

The system 20 interacts with source systems 25 such as legacy computer systems, ERP solutions, CRM systems, and other systems from which data is desired. These source systems 25 are typically operational/transactional systems with full-time (e.g., 24 hours per day, every day) up-time requirements. The desired data includes some, if not all, of the massive amounts of data collected by a business using the source systems 25. The data generally concerns the many different aspects included in the operation of a business. Each of the source systems 25 may include types of data that are different than the types of data stored in the other source systems 25, and each of the source systems 25 may store this data in a format different from the formats of the other source systems 25. Therefore, a number of source systems 25 may include data about a single subject or entity (e.g., a customer) in multiple formats (e.g., a first source system 25 includes data in a first format about web related activities of a customer, a second source system 25 includes data in a second format about catalog related activities of the customer, and a third source system 25 includes data in a third format about the store related activities of the customer). Although the data stored in different source systems 25 and in different formats is all applicable to the same subject, the differences in the formats of the data often makes consolidation of the data difficult. A business can be adversely affected if the business decisions it makes is not based upon all available data. Therefore, the system 20 is utilized to provide a data solution that brings the data from a number of different source system 25 together for use by a business in making business decisions.

The system 20 includes seven major data storage areas that can be combined on a single platform, replicated across platforms, or reside on multiple platforms to handle load and scalability of data. Each of these areas is discussed in greater detail below.

Data from the source systems 25 is delivered to a profiling and cleansing module 30. The profiling and cleansing module 30 may perform a profiling function and a cleansing function. The profiling and cleansing module profiles data by analyzing sources systems 25 and determining a content, a structure, and a quality, of the data delivered from the source systems 25. A normalized data model is then generated. The profiling function of the profiling and cleansing module 30 may be implemented using presently available software including Knowledge Driver software available from Knowledge Driver Corporation. The profiling and cleansing module 30 cleanses the data from the source systems 25 by synchronizing, organizing, and integrating the content. The cleansing function of the profiling and cleansing module 30 may be implemented using presently available software including Data Right, ACE, and Merge Purge software available from First Logic.

Data profiling includes looking for data patterns within columns and cells of data from the source systems 25. Data profiling is necessary for validating the content of the data from the source system 25 before it is fed into the data storage areas of the system 20. During the process of data profiling, data that requires data cleansing is pointed out.

Data cleansing standardizes and consolidates customer data anywhere data is touched, stored, or moved within an enterprise. Organizations can make better business decisions with synchronized and cleansed data. The cleansing process provides accurate, complete, and reliable data for data warehouses or data marts. A typical cleansing engine can parse, correct, standardize, enhance, match, and consolidate source data. Items such as customer names, business names, floating, unfielded data, professional titles, post names, and business suffixes are typically handled by cleansing. Other components in the cleansing engines handle customer demographics, phone numbers, geographic codes, gender codes, etc. Other components of the cleansing engine handle tie-breaking configuration rules and scanning of free-form fields.

The final view of profiled and cleansed source data is much more accurate than the data originally present in the disparate source systems 25. The profiled and cleansed data is more valuable to the enterprise and can be warehoused in a standardized fashion as opposed to building islands of source data in an operational data store (“ODS”) structure.

Profiled and cleansed data from the profiling and cleansing module 30 is delivered to a storage area 35, sometimes referred to as a data dock. Metrics and metadata representative of the profiling and cleansing processes may also be saved in a metrics and metadata repositories (discussed below). The storage area 35 is a repository for operation sources of data. Preferably, storage area 35 is fed data in a real-time or near real-time fashion using messaging middleware tools such as Informatica PowerCenter/PowerMart, IBM MQSeries, or TIBCO ActiveEnterprise.

The storage area 35 has data models and constraints similar to those of the source systems 25. However, uptime isn't as critical for the storage area 35 as it is for the source systems 25 because the storage area 35 captures operational data and not user data. This in turn makes accessing data from the storage area 35 easier than accessing data from the source systems 25 because access can be achieved without impacting operational users. The storage area 35 acts like an ODS, except that in the invention it is preferred that the storage area 35 reside on a single relational database management system (“RDBMS”) regardless of the source data. This characteristic allows for the storage area 35 to perform a first level of integration. The storage area 35 can port data between and around sources, and act as the source of data. The storage area 35 acts only as a temporary storage. The storage area 35 maintains data for a predetermined amount of time and then feeds the data to successive components of the system 20 or deletes the data.

Data from the storage area 35 is delivered to a second storage area or staging area 40 in the system 20 through a first metagate 42. The first metagate 42 provides data integration and a data movement framework; this data passes through either a trickle feed (near real time process), or a bulk-move or bulk-copy feed. The first metagate 42 provides data loading functionality for the staging area 40. In one embodiment, data from the storage area 35 is delivered to the staging area 40 in the system 20 through a bulk extraction, transformation, and load (“ETL”) process. The staging area 40 may receive data directly from the source systems 25. However, data may also be loaded in parallel from the storage area 35 and the source systems 25. The exact manner of loading the data is determined, in large part, by cost. Placing data in the storage area 35 and then the staging area 40 is preferred, but results in higher cost. The staging area 40 focuses data into a single area on a single RDBMS and is built to house one-for-one images (snapshots) of the source data. The staging area 40 is completely refreshed with each load of a data vault or storage device 45. The staging area 40 may be implemented using presently available software including PowerCenter or PowerMart (data movement/bulk load) software from Informatica Corporation.

A data warehouse implementation team (discussed below) typically owns or has responsibility for creating and maintaining the staging area 40. This ownership can be important when tuning source data for speed of access by the processes that are required to load the data for the end-user within pre-determined time frames. The staging area 40 is designed with independent table structures in a parallel configuration to allow for a high degree of tuning, and minimal contention and locking in the database. The design also permits massively parallel bulk loading of data from both large and small sources systems 25. Data is thereby made available much faster for further processing downstream. Further, because the staging area 40 includes a snapshot of the data going into the data warehouse, backups of the staging area 40 and re-loads of bad or short data delivered by the source systems 25 may be executed. The staging area 40 provides consistent and reliable access without going across the network with large load times to the loading cycle of the next storage area.

As discussed above, the staging area 40 is designed for bulk loading. However, the structure of the staging area 40 can be modified through the use of common data modeling tools such as ER-Win from Computer Associates, or PowerDesigner from Sybase, to accommodate near real-time, or trickle-feed loading.

Data from the staging area 40 is delivered to the third storage area or data vault 45 through a second metagate 47. The second metagate 47 improves the quality of the data by integrating it, and pre-qualifying it through the implementation of the business rules. Data that fails to meet the business rules is either marked for error processing or discarded. The storage device 45, sometimes referred to as a data vault, facilitates the process of data mining. The storage device 45 houses data from the functional areas of the business. Data mining fits into the methodology of the system 20 by providing the final component to data access, particularly, the data built over time into a functional area of the business. Data movement and integration software such as PowerCenter/PowerMart provided by Informatica Corporation and data mining software (Enterprise Miner) provided by SAS Corporation are suitable for implementing the storage device 45.

Data from the data storage device 45 passes through a third metagate 50 to a fourth storage area 55, sometimes referred to as a data mart. The fourth storage area 55 may be a subset or a sub-component of a larger data warehouse. As such a sub-component, the fourth storage area may be used to store the data for a single department or function. The fourth data storage area 55 may be configured in a star schema and is, in one embodiment, split into aggregations and different subject area components. When so configured, the fourth storage area 55 offers the capabilities of aggregates, such as drill-down, decision support systems (“DSS”) and on-line analytical processing (“OLAP”) support. The storage area 55 is dynamically built, designed, and rebuilt from inception to date with data housed in the data storage device 45. In one embodiment, the design and architecture of storage area 55 is accomplished by the business analyst (of the implementation team 22) who performs a business analysis, and data modeling using ER-Win from Computer Associates. The storage area 55 is then generated into the target database. Data movement processes are then designed using PowerCenter/PowerMart from Informatica Corporation to move the data into storage area 55. This permits an end use (e.g., a business) to quickly reconfigure the delivered data by working with the implementation team 22. Without this capability, the storage area 55 cannot cross subject areas or re-integrate its data easily. The fourth storage area 55 serves data quickly to the end-users. In general, end users need data as quickly as possible to make business decisions based on current and up-to-date data. Brio Enterprise and Brio Portal are two examples of software that can be utilized to implement the data storage area 55.

When the fourth storage area 55 grows too big or when the fourth storage area 55 cannot deliver data fast enough for vertical reports, the system 20 may be implemented with a data collection area 57. The data collection area 57 is a flattened or de-normalized database (i.e., a pre-computed intermediate aggregate table). When using the data collection area 57, pre-aggregated data can be delivered to end users in roughly half the time it takes the fourth storage area 55 to deliver the same amount and type of data from a query against aggregated data. The difference is the flexibility of the data collection area 57. The data collection area 57 supports high speed access across millions of rows of data and extensive search criteria of the data. However, the data collection area 57 does not support OLAP tools, drill-down, or DSS, because it has been de-normalized.

The data collection area 57 is optional. When used, it provides the capability to share or send data to printers across an organization or to wireless or wireless area protocol (“WAP”) devices with limited input capabilities. Flexibility is also provided in the case of thin client XML/HTML data access against flat tables. Brio Enterprise, Brio Portal, Java-Web Server, and Email Server are examples of software that can be used to implement the data collection area 57.

A metrics repository 60 collects statistics about the processes, physical size, and growth and usage patterns of the different components that make up the system 20. These software metrics or numerical ratings are used to measure the complexity and reliability of source code, the length and quality of the development process, and the performance of the application when completed. Enterprises can measure the success of the data warehousing project as well as identify and quantify future hardware upgrade needs by utilizing the metrics. The system 20 allows users to see how frequently the warehouse is used as well as what content is being accessed. The metrics can also help administrators track dead or old data that needs to be rolled off or deleted.

A metadata repository 65 is another component of the system 20. As is known, metadata is data that describes other data (e.g., any file or database that holds data about another database's structure, attributes, processing, or changes). The metadata repository 65 is used to capture data about processes and business rules that flow through the system and act as a point in the system 20 where business intelligence (“BI”) and DSS tools can access data. The data is typically gathered from the recommended tool sets, and from any other components that operate on the data.

Data in the metadata repository 65 facilitates understanding of the cycle and flow of data from one end of system 20 to the other and provides knowledge about the processes taking place in the system 20, how the processes link together, and what happens to the data as it flows from storage area to storage area. This data is typically utilized by data warehousing staff to help document and mentor end-users.

Data from the fourth storage area 55 and data collection area 57 is transferred to a BI and DSS module 75. The system 20 can send its output back to the source systems 25 (including CRM and ERP applications) and user portals. However, to receive, understand, query, or use the data in the system, a BI solution (such as OLAP, data mining, etc.) must be used. Accordingly, the BI and DSS module 75 includes analysis tools, report generator tools, and data mining tools. Data from the fourth storage area 55 can also be passed on to various corporate portals (i.e., end users) represented by the box 85.

Executive decision makers, which are represented by the box 87, impact the system 20. Executive decision makers are users who oversee the allocation of resources necessary during implementation of the system 20. They also are the users who typically gain the most from the enhanced data output of the system.

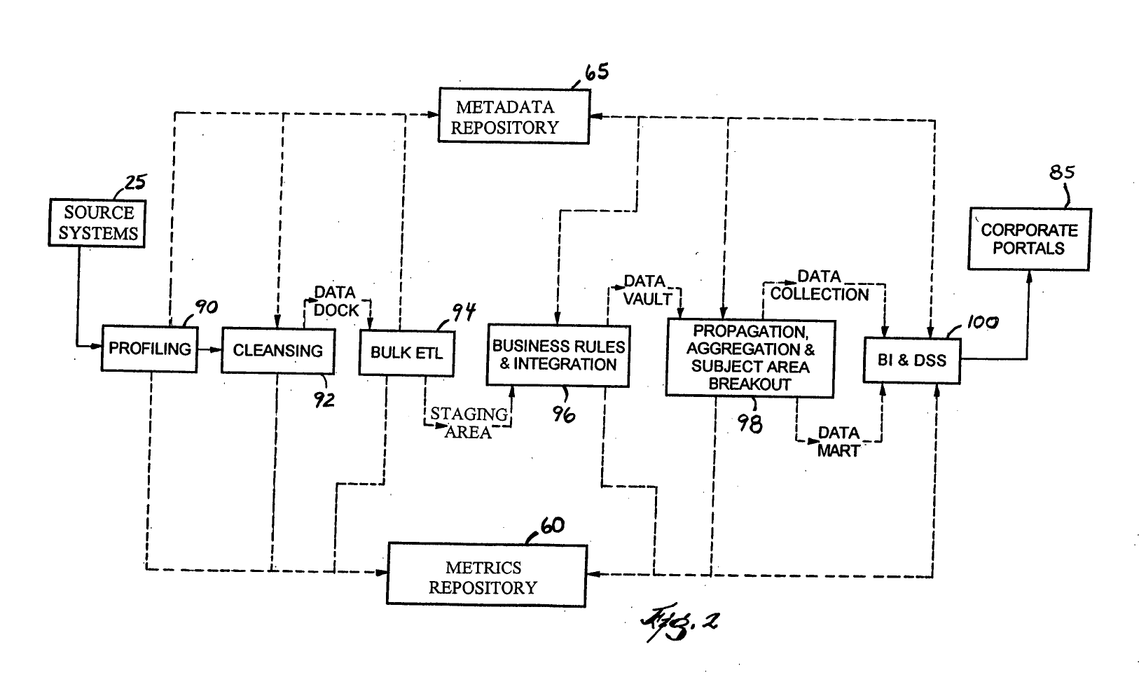

As shown in FIG. 2, the system 20 can be viewed as containing a plurality of process areas including a profiling process area 90, a cleansing process area 92, a data loading area, or more specifically, a bulk ETL process area 94, a business rules and integration process area 96, a propagation, aggregation, and subject area breakout process area 98, and a BI and DSS process area 100. FIG. 2 schematically illustrates the flow of data through the storage areas and metagates discussed above. The processes of the process areas 90-100 can be done in whole or in part within the storage areas. The process areas 90-100 generate and utilize both metrics and metadata as they perform processes. The metrics and metadata from the process areas 90-100 are stored in the metrics repository 60 and the metadata repository 65, respectively. The value of the data increases as it makes its way from the source system 25 through the process areas 90-100 to the corporate portals 85. The data is more valuable because it can be utilized by the end users to make better business decisions. The result of the data flowing through the process areas 90-100 is greatly increased data quality, accuracy, and timeliness.

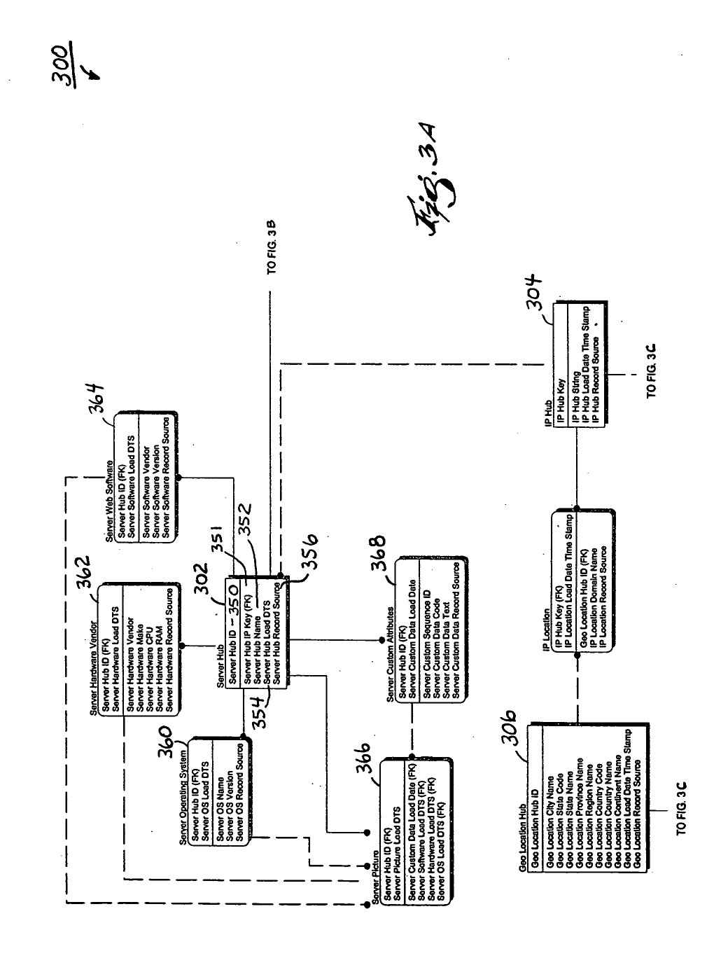

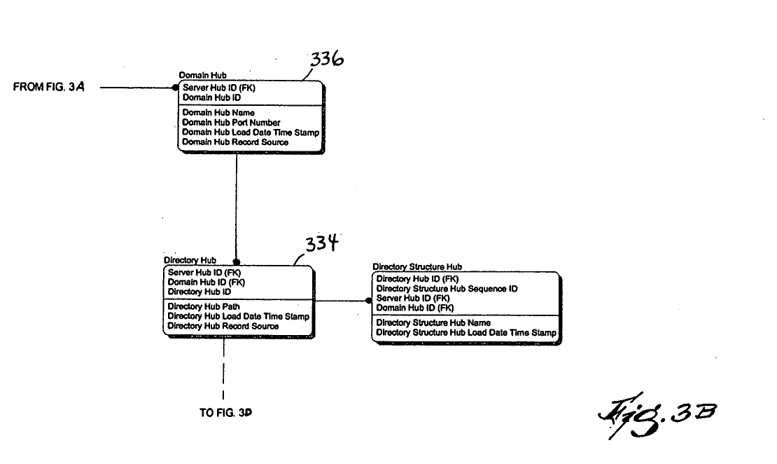

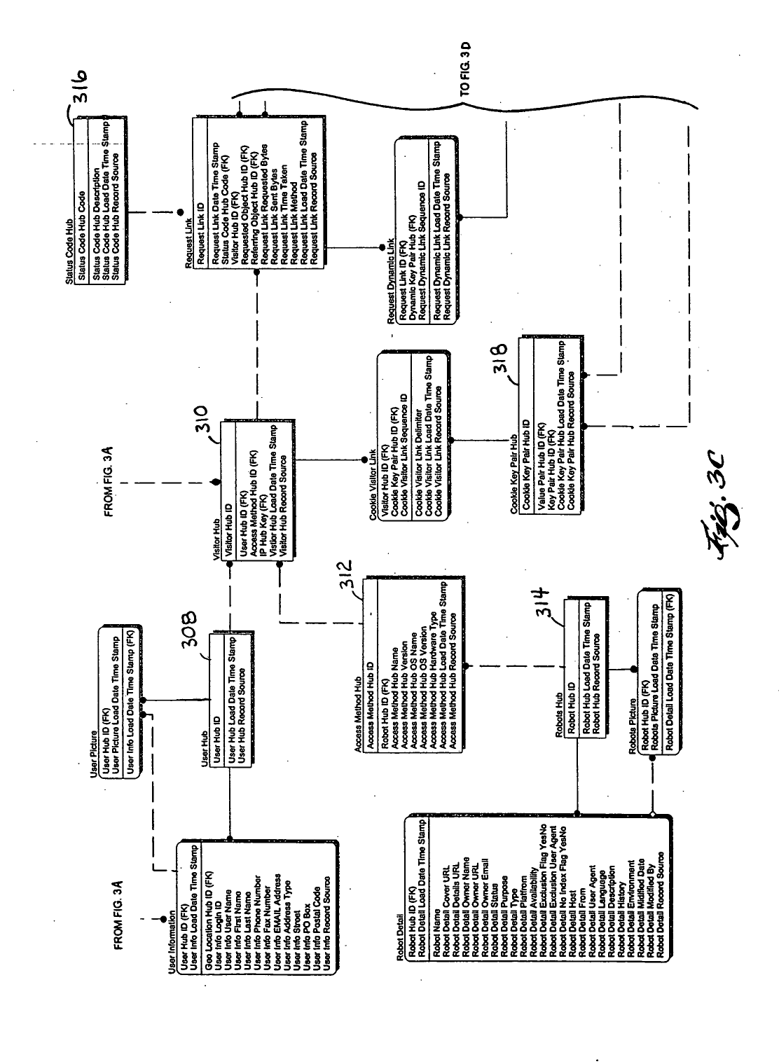

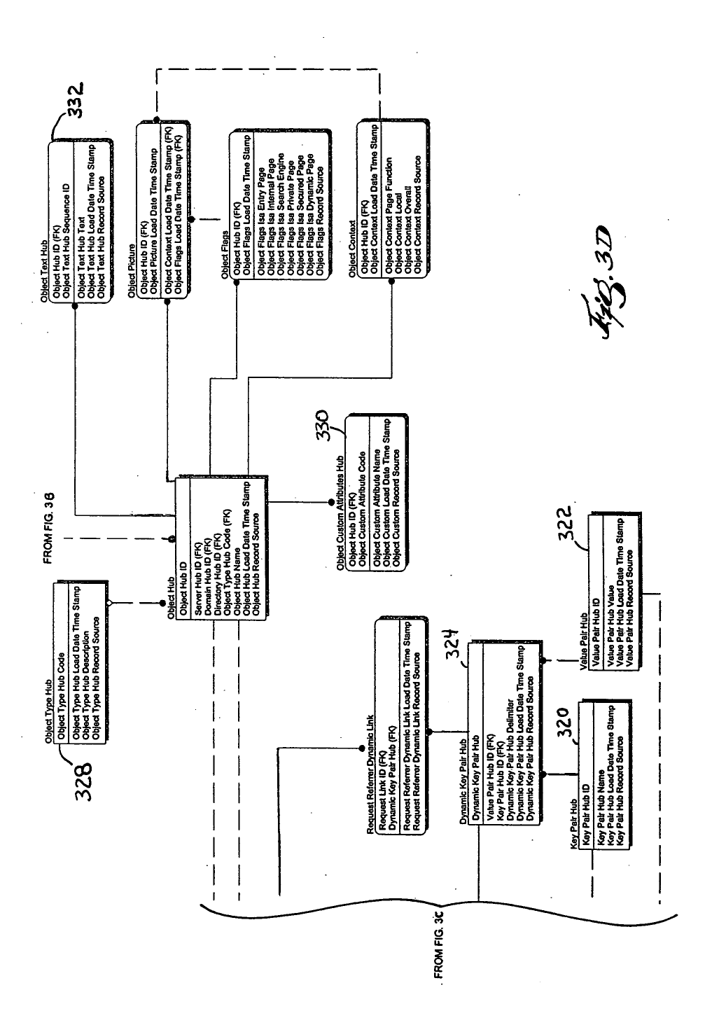

FIGS. 3A-3D illustrates a data model 300 that defines the architecture of one embodiment of the data storage device or data vault 45. The data model 300 defines the architecture of the storage device 45 when configured to store data from a web site. The data model 300 includes a plurality of tables or entities relationally linked to, or associated with, one another by a number of links or branches. A solid line (i.e., link) represents a required relationship where the primary key is migrated from a parent table to a child table. A dotted line (i.e., link) represents a non-required relationship where at least some parts of the primary key may or may not migrate from the parent table to the child table. Cardinality is indicated by the presence of a solid dot or diamond at the end of a relationship branch. An entity with a diamond or solid dot next to it is the “child” of at least one “parent” entity. In general, a “parent” entity can have numerous “children.” In other words, if the terminating end of a relationship branch has a solid dot (or diamond), an instance of the originating entity can be related to one or more instances of the terminating entity. If the terminating end is a straight line, an instance of the originating entity can be related to only one instance of the terminating entity.

The data model 300 illustrated in FIGS. 3A-3D includes a plurality of hubs and a plurality of satellites linked to each of the plurality of hubs. The plurality of hubs includes a server hub 302, an IP hub 304, a geographic location hub 306, a user hub 308, a visitor hub 310, an access method hub 312, a robots hub 314, a status code hub 316, a cookie key pair hub 318, a key pair hub 320, a value pair hub 322, a dynamic key pair hub 324, an object hub 326, an object type hub 328, an object custom attributes hub 330, an object text hub 332, a directory hub 334, and a domain hub 336.

Essentially, each hub can be viewed as a table, the table including a header and a fields section or detail table. The header for a hub table generally includes an identification (“ID”) (or primary key) of the hub (e.g., the header of the robots hub 314 table includes a robot hub ID). If a particular hub is a child to a parent entity and linked to that parent entity by a solid line, the header may also include an ID (or foreign key) for that parent entity (e.g., the header of the domain hub 336 table includes a domain hub ID (primary key) as well as a server hub ID (foreign key)). The fields section typically includes all attributes of the table, and if the hub is a child to a parent entity and linked to that parent entity by a dashed line, the fields section may also include a foreign key for that parent entity. The attributes included in the fields section of a hub generally include a load date time stamp (“DTS”) which indicates the loading time of the primary key in the hub and a record source which indicates the source of the primary key for the hub.

In one embodiment, each hub is linked to at least one satellite entity and at least one other hub table. A small data model may only include a single hub, but data model 300 includes a plurality of hubs. The data model 300 illustrated is only representative and can be expanded to include additional hubs and additional satellites.

Each satellite table also includes a header and a fields section. The header of the satellite table generally includes a DTS for the satellite. If the satellite is a child to a parent entity and linked to that parent entity by a solid line, the header may include a foreign key for that parent entity. The fields section of the satellite typically includes all attributes of the table, and if the satellite is a child to a parent entity and linked to that parent entity by a dashed line, the fields section of the satellite may include a foreign key for that parent entity.

A description of the server hub 302 is used to illustrate the linking between a hub and satellites of the hub and other hubs. The business function of the server hub 302 is to hold a list of web servers by IP address. The server hub 302 includes a header containing a server hub ID 350. The server hub 302 also includes a fields section containing a server hub IP key 351, and a number or attributes; including a server hub name 352, a server hub load DTS 354, and a server hub record source 356. The server hub 302 has a number of satellites including a server operating system satellite 360, a server hardware vendor satellite 362, a server web software satellite 364, a server picture satellite 366, and a server custom attributes satellite 368. The server hub 302 is also a parent entity of the domain hub 336 which is linked to the server hub 302 by a solid line, and a child entity of the IP hub 304 which is linked to the server hub by a dashed line.

The server operating system satellite 360 includes a header containing a server hub ID foreign key 370 and a server operating system DTS 372. The server operating system satellite 360 also includes a fields section containing a number of attributes; including a server operating system name 374, a server operating system version 376, and a server operating system record source 378. The satellites 362-368 all have a server hub ID (i.e., a foreign key for the server hub 302) (which join or link the “child” or satellite entity to the “parent” or hub entity) and attributes as indicated in FIG. 3A, and for purposes of brevity are not discussed further herein.

The remaining hubs and satellites illustrated in FIGS. 3A-3D are similar to those discussed with respect to the server hub 302 and also are not discussed herein. Following is a table that further explains the business functions performed by each of the entities included in the data model 300.

| | |
|---|---|
| Access | This hub houses a list of access methods. A visitor may obtain access |
| Method Hub | using a browser, an editor like FrontPage, and/or others methods |
| | including a “spider“ (more commonly known as a “robot“). The data |
| | about the access methods is derived from a user agent field of the web |
| | log. The data can include items like the operating system used, version |
| | of the operating system used, and the hardware platform the operating |
| | system is located on. Data about an access method is recorded once for |
| | each kind of access method. Since the data about each access method is |
| | unique, there is no history to track. If the access method is not a robot or |
| | a spider, the robot ID is set to “ − 1“ (negative one) even though that is |
| | considered text. If the access method is a robot spider, the key is |
| | populated with a real ID string, thereby defining the robot hub and the |
| | detail to house a “−1“ keyed robot with a name of none. |
| Cookie Key | This hub houses a key-value pair for each variable specified in a cookie. |
| Pair Hub | Generally, each visitor has their own cookie, assuming the program is |
| | properly written. Most browsers commonly have a cookie feature turned |
| | on to allow tracking of the visitors. As the visitor logs in, data is |
| | captured including the username of each visitor, thereby tying the visitor |
| | back to an actual person. Additional data about how long the visitor |
| | stayed on the outside before logging in, and when the visitor actually did |
| | log in can also be tracked. Since the keys and values cannot be tracked |
| | with respect to changes over time, this is a hub table and not a satellite. |
| Cookie | This table tracks each visitor to a specific set of cookie keys and values. |
| Visitor Link | The sequence ID identifies which order a particular cookie was in on the |
| | web log line. There is one of these rows for each visitor and key-value |
| | pair on the cookie line. The delimiter of the cookie is also housed here. |
| Directory | This hub houses a list of unique paths to objects. Each resource path that |
| Hub | is unique receives a new directory ID. To avoid recursive relationships |
| | (because directories are hierarchical) directory names are separated, and |
| | sequence ordering is accomplished in a child satellite. |
| Directory | This hub includes the structure breakdown of the directory. Each |
| Structure | directory is broken down into a series of directory names. The order of |
| Hub | each directory is provided by a sequence ID. The base directory is |
| | always considered to be a structure sequence 1 . Typically directory |
| | names change, thereby resulting in new entries to the structure. There |
| | really is no good way to track the change of old directory names to new |
| | directory names that ensure that each directory name change is captured. |
| | However, by using a hub table the old directory link which an object was |
| | in can be tracked along with the new directory that the object is now in |
| | by looking to see when activity stops on the old object and starts on the |
| | new one. |
| Domain | This hub provides a list of domains organized by web server. One web |
| Hub | server may serve many domains. However a single domain must exist |
| | only on one web server. Domains are considered to be virtual by nature. |
| Dynamic | This table links the dynamic request (single web log line) to a specific |
| Key Pair | dynamic key-value pair set. The dynamic requests can be search |
| Hub | conditions, or clauses entered on a form, or data needed to be passed to |
| | server objects. The sequence ID in this table indicates the order on the |
| | web log line in which the dynamic requests appear. A delimiter is also |
| | stored here. The delimiter usually is consistent across key-value pairs. |
| | This table is a hub because a new log line with a different order, or |
| | different keys, generates new surrogate keys in the child hub tables. |
| Geo | This table holds state, province, region, country, and continent data. |
| Location | Typically, states do not change names once assigned, and the |
| Hub | geographical location of states is static. This is a hub of data because the |
| | geography is consistent over time. |
| IP Hub | This table houses a list of all the IP addresses. The IP addresses are |
| | decoded to be integer based. Any IP address used by any server, or by |
| | any client, is recorded in this table. The first time an IP address is |
| | recorded, it is date and time stamped. The string representation of the IP |
| | address is also available for clarity and ease of use. |
| IP Location | This table links an IP address to a geographical location. The |
| | geographical location of an IP address does not change over time outside |
| | of state boundaries based on the way IP addresses work. Even with |
| | DHCP and dynamic assignment, an IP address is confined to a specific |
| | city, or building. Therefore, this is a hub of IP addresses linked to |
| | geographical locations. This table includes the domain name as well, |
| | which could change over time. However, tracking history data about |
| | domain name changes is not required in all implementations. |
| Key Pair | This hub holds the key side of the key-value pair. In a dynamic line |
| Hub | issued to the server, or a cookie, the format is usually: |
| | key =value<delimiter>key =value, etc. This hub is a list of all of the keys |
| | found in a request, or in a cookie. The key name is the business key, so |
| | changes to the name result in a new entry. Thus, it is a hub table because |
| | changes to the name over time cannot be tracked, therefore it cannot be a |
| | satellite. |
| Object | This table houses context of local and overall objects. If a local object is |
| Context | housed, the context could be defined as a sub-web (if sub-webs have |
| | been identified), if an overall object is housed, it may be available to |
| | everyone. |
| Object | This table houses custom attributes that the loader of the data vault |
| Custom | wishes to include. The business key is the attribute code, followed by the |
| Attributes | attribute name or description. These attributes are content about an |
| Hub | object, which are preferably loaded by the loader ahead of time. The |
| | loaded attributes are used to describe objects. The user must load the |
| | object table from a list created on their web server, and link it to custom |
| | attribute codes. |
| Object Flags | This table houses computed flags for each object. The business rules for |
| | each object are determinant. An entry page is any page that does not |
| | require a login, and can be book marked. An internal page is any page |
| | that requires a login to access. A search engine page is any page that |
| | feeds the search engine on the site. A private page is one used by |
| | internal access only, requiring access to the server and not accessible |
| | through the web site. A secured page is one sitting on an HTTPS or SSL |
| | layer, and a dynamic page is any page with key-value pairs attached. |
| Object Hub | This table holds the actual object itself. The object could be a web page, |
| | a picture, a movie, or anything else that is referenced. If the object has a |
| | web server ID of zero, it is considered to be an external, or unknown web |
| | server (coming from a referring page for instance). This table is created |
| | dynamically for each object on the web log line, including referring |
| | objects. As mentioned in the Object Custom Attributes Hub section, this |
| | object table can be preloaded from a web-server list of objects if the |
| | loader wants to specify their own attribute codes and names to describe |
| | the object. |
| Object | This table houses the history of object details, such as flags, and context. |
| Picture | The latest picture, and past pictures of each are kept here. The most |
| | recent or current picture is available by performing a max function on the |
| | table's load date time stamp, then directly matching the child tables that |
| | house corresponding history or deltas. |
| Object Text | This table holds a series of user-defined text. This data is preloaded like |
| Hub | the Object Custom Attributes table. These items allow further extension |
| | or definition of the object itself. Since the text is the business key, |
| | tracking this text over time is difficult. There is no indication of being |
| | provided old and new text or changes to the business key, so tracking |
| | changes over time is difficult. |
| Object Type | This table holds the object extension. For instance: .jpg, .gif, .html, .xml, |
| Hub | etc. |
| Request | This link table links a series of dynamic key-value pairs to a requesting |
| Dynamic | object in the request table above it. The sequence number orders the |
| Link | key-value pairs in the order they are seen on the request line. If the order |
| | changes, or there is a new request, new link records are generated. |
| | However, the duplication of key-value pair data is alleviated. |
| Request | Each web log line is an actual request of an object by a visitor that may |
| Link | or may not have a cookie to identify themselves. Each web log line has a |
| | potential referring object (where it came from), and potentially a |
| | dynamic set of key-value pairs requested, or referred from. With each |
| | web log line, a new request record is built. This table grows rapidly, and |
| | quite possibly records duplicate data (outside of the date time stamp). |
| | The request link date time stamp is the field that is generated from the |
| | web server itself to indicate when this request was made against the |
| | server. Each request is filled with data by the server such as status, time |
| | taken, method, bytes sent and received. These statistics are the |
| | foundation for aggregates such as session, total time, number of visits |
| | versus number of hits, etc. |
| Request | This non-recursive table links the request line (which may have a |
| Referrer | referring object) to the referring object. If the referring object has a |
| Dynamic | dynamic set of key-value pairs, then they are linked here. Each web log |
| Link | line has one and only one requested object, and one referring object. |
| | However, if there is no referring object, the ID will be zero for the key- |
| | value pair, which links to text to indicate NA values. |
| Robot | This table houses a predefined list of robots or spiders. The source for a |
| Detail | robot is external and defined by the W3C on its web site. The data is |
| | massaged, and pre-loaded. The robot key is the actual robot ID provided |
| | by the list of robots and is a text string in all cases. |
| Robots Hub | This is the hub or list of robot keys. |
| Robots | This table holds past and current historical pictures of each of the robots. |
| Picture | |
| Server | This table holds a list of sequenced attributes that are customized by the |
| Custom | user to house additional data about the server. There can be as many |
| Attributes | attributes as desired by the user. |
| Server | This holds the server hardware description including data about the |
| Hardware | amount of RAM, the number of CPUs, the vendor, and the model of the |
| Vendor | hardware. |
| Server Hub | This table holds the list of web servers by IP Address. The IP address is |
| | the only consistent attribute that (usually) does not change once assigned. |
| Server | This table houses operating system data for the web server. |
| Operating | |
| System | |
| Server | This table holds both past and current historical pictures of each of the |
| Picture | satellite tables. The current picture is located by obtaining the most |
| | recent date (i.e., the max date) from this picture table, and then directly |
| | linking to the satellite tables desired. |
| Server Web | This table houses historical data about the web server software, including |
| Software | the version, make, and vendor. |
| Status Code | This table houses a list of status codes and descriptions that can be fed |
| Hub | back by the server for each request. The list typically does not change |
| | over time, thereby allowing the table to be built as a hub. If the list does |
| | change, however, it does not matter because the history of this table does |
| | not need to be tracked. |
| User Hub | This hub links users to visitors. If a cookie is provided with a user login |
| | ID, then the visitor can be identified. This is a list of user surrogate keys, |
| | typically pre-generated from another system. |
| User Data | This table houses data about the user. If the surrogate keys from another |
| | system have been used, this table need not necessarily be implemented. |
| | When the surrogate keys from another system are used, all that is |
| | necessary to identify each user is their respective login ID. This table |
| | also can be utilized to link the user data to geographical locations (if |
| | available), which can thereby group the users across IP addresses |
| | according to their geographical location, which in turn demonstrates |
| | which domains and servers the users are associated with. |
| User Picture | This table holds the current picture of the user data. This table is not |
| | necessary unless there is more than one satellite hooked to the user hub. |
| | This table is included for demonstrative purposes of the current picture, |
| | and holds all the same necessities as described in the other picture tables. |
| Value Pair | This hub holds the value side of the key-value pairs mentioned in the |
| Hub | Key Pair Hub table description. The value side is either entered into the |
| | form by a CGI script, or assigned to a cookie key. Since the value side is |
| | itself a business key, the Value Pair Hub is a hub table, and not a |
| | satellite. |
| Visitor Hub | This table houses visitor objects. Each IP address is a visitor, across a |
| | specific time period of requests. Without cookies it is difficult to identify |
| | visitors. With cookies, each visitor becomes unique and distinct, as long |
| | as there is a cookie per visitor. Where a user login id is available, it will |
| | be matched up to pull in user data. It will also link each visitor to the |
| | cookie key-value pairs that they own. |

As noted above, the system 20 can be configured and built by an implementation team 22. The implementation team 22 includes a group of experts trained to perform consulting in a specialized manner. Each team member is assigned certain roles and responsibilities. Each member provides mentoring, cross-training, and support through the course of implementing the system 20. The goal of the implementation team 22 is to meet an organization's needs with minimal expense and a maximum output. When implementation of a data solution is complete, the enterprise is left with staff who can maintain and expand the system 20. The enterprise also is provided with documentation and deliverables. In one embodiment, the implementation team 22 includes the following members (shown in FIG. 4):

1. A project manager 400 whose function is to manage the implementation of the system 20 at client sites. This is accomplished by adhering to best practices, which include project management, project planning, activity scheduling, tracking, reporting, and implementation team staff supervision. This role is the primary driver of major milestones including coordination and communications with the organizations, business user groups, steering committees, and vendors.

2. A business analyst 402 whose function is to interface with the end-users, collecting, consolidating, organizing, and prioritizing business needs. The business analyst ensures that all end-user requirements are incorporated into the system 20 design and architecture. This role provides the conduit for communication of the organization's requirements to the implementation team for implementation purposes.

3. A systems architect 404 whose function is to provide the blueprint for the hardware, software, and interfaces that defines the flow of data between the components of the system 20. Additionally, this role guides the selection process of standards, sizing (hardware/software/database), and suggested tool sets. This role provides the implementation team with the bandwidth to begin sizing the data sets and warehousing effort in relation to the system 20. The architect is responsible for defining the flow of data through the end-user business intelligence tool sets.

4. A data modeler/data architect 406 whose function is to model and document the source system and business requirements. Key activities revolve around interpreting logical database design and transforming it into a physical data design, as well as applying appropriate business rules. The data modeler/data architect maximizes efficiency and sizing of the physical structures to handle user reports and queries.

5. A data migration expert 408 whose function is to determine and develop the best solution to migrate and integrate data from various sources. The system 20 uses an ETL tool approach rather than hand-coding, to achieve rapid deployment. The data migration expert handles all implementation, troubleshooting, mentoring, and performance tuning associated with the ETL tool selected for use in the system 20.

6. A DSS/OLAP expert 410 whose function is to determine and develop the best reporting solution or DSS based on end-user requirements and to implement any OLAP tools selected for use in the system 20. The DSS/OLAP expert is responsible for understanding the organization's data in a detailed manner. This role is also responsible for designing the most effective presentation of the data, resulting in effective decision making.

7. An optional data cleanser/profiler 412 whose function is to determine which business rules apply to which data. During profiling, the responsibility includes data analysis and measurement against the business requirements. The role dictates implementation of specific profiling activities as a result of the cleansing efforts. This is an optional role in the implementation team because the activity of cleansing and profiling can be addressed after the initial implementation of the system 20.

8. An optional trainer 414 whose function is to train end users on the tools and methods necessary to use the system 20. For example, the trainer may provide specific training sessions on ETL and OLAP tools.

As can be seen from the above, the invention provides, among other things, a method and system of data warehousing. Various features and advantages of the invention are set forth in the following claims.

What is claimed is:

1. A method of building business intelligence, the method comprising:
receiving data from at least one source system of an enterprise, wherein the data is representative of business operations of the enterprise;
delivering the data to a staging area via a first metagate, wherein the staging area focuses the data into a single area on a single relational database management system;
delivering the data from the staging area to a data vault via a second metagate, wherein the data vault houses data from functional areas of the enterprise;
delivering the data from the data vault to a data mart via a third metagate, wherein the data mart stores data for a single function of the functional areas of the enterprise;
transferring data to at least one of a business intelligence and decision support systems module, a corporate portal module, and at least one of the at least one source system of the enterprise;
collecting metrics in a metrics repository; and
collecting metadata in a metadata repository.

2. A method as claimed in claim 1, further comprising profiling and cleansing the data received from the at least one source system to produce profiled and cleansed data.

3. A method as claimed in claim 2, further comprising delivering the profiled and cleansed data to a data dock.

4. A method as claimed in claim 3, wherein the act of delivering the profiled and cleansed data to the data dock is accomplished using middleware tools.

5. A method as claimed in claim 3, further comprising including operational data in the data dock.

6. A method as claimed in claim 3, further comprising positioning the data dock on a single relational database management system regardless of the data received from the at least one source system.

7. A method as claimed in claim 6, further comprising porting data between and around sources using the data dock.

8. A method as claimed in claim 3, further comprising maintaining data in the data dock for a predetermined amount of time, and then after the predetermined amount of time has elapsed, proceeding to one of a first condition and a second condition, wherein the first condition is deleting the data, and wherein the second condition is the act of delivering the data to a staging area

9. A method as claimed in claim 8, wherein the act of delivering data to the staging area is done in parallel from the data dock and the at least one source system.

10. A method as claimed in claim 1, wherein the act of delivering data to the staging area is done directly from the source systems.

11. A method as claimed in claim 1, wherein data integration and a data movement framework are provided by the first metagate.

12. A method as claimed in claim 11, wherein one of a data loading process, a near real-time load process, and a trickle feed load process are performed in the data movement framework.

13. A method as claimed in claim 1, further comprising housing snapshots of the data received from the at least one source system in the staging area.

14. A method as claimed in claim 1, wherein the staging area includes independent table structures in a parallel configuration to allow for tuning the data received from the at least one source system for speed of access.

15. A method as claimed in claim 1, wherein the staging area is refreshed with each act of delivering the data from the staging area to the data vault.

16. A method as claimed in claim 1, wherein the data vault facilitates the process of data mining.

17. A method as claimed in claim 1, wherein the second metagate improves the quality of data through integration and pre-qualification of the data using an implementation of business rules.

18. A method as claimed in claim 17, wherein data that fails to meet the implementation of the business rules is marked for one of error processing and discarding.

19. A method as claimed in claim 1, wherein the data mart is configured in a star schema.

20. A method as claimed in claim 1, wherein the data mart is split into aggregations and different subject areas.

21. A method as claimed in claim 20, wherein the data mart offers capabilities of aggregates, including at least one of drill-down, decision support systems, and on-line analytical processing support.

22. A method as claimed in claim 1, further comprising delivering the data from the data mart to a data collection area.

23. A method as claimed in claim 1, wherein the metrics are utilized for at least one of measuring a complexity of source code, measuring a reliability of source code, measuring a length of a development process, measuring a quality of a development process, measuring a performance of an application, identifying future hardware upgrades, quantifying future hardware upgrades, determining frequency of use, determining content accessed, and tracking data.

24. A method as claimed in claim 1, wherein the metadata is utilized for at least one of facilitating understanding of the cycle and flow of data, and providing knowledge of processes on the data.

25. A data migration, data integration, data warehousing, and business intelligence system comprising:
a profiling process area;
a cleansing process area;
a data loading process area;
a business rules and integration process area;
a propagation, aggregation, and subject area breakout process area; and
a business intelligence and decision support systems process area.

26. A system as claimed in claim 25, further comprising a metadata repository.

27. A system as claimed in claim 25, further comprising a metrics repository.

28. A system as claimed in claim 25, wherein data is delivered to the profiling process area from at least one source system of an enterprise.

29. A data migration, data integration, data warehousing, and business intelligence system comprising:
a staging area;
a data vault;
a data mart;
a metrics repository; and
a metadata repository.

30. A system as claimed in claim 29, further comprising a data dock.

31. A system as claimed in claim 30, wherein data from at least one source system of an enterprise is delivered to a profiling and cleansing module which produces profiled and cleansed data.

32. A system as claimed in claim 31, wherein the profiled and cleansed data is delivered to the data dock.

33. A system as claimed in claim 32, wherein the data is delivered to the staging area from the data dock.

34. A system as claimed in claim 29, further comprising a data collection area.

35. A system as claimed in claim 34, wherein data is delivered to at least one of a business intelligence and decision support systems module, a corporate portal module, and the at least one source system from at least one of the data mart and the data collection area.

36. A system as claimed in claim 29, wherein the data vault includes at least two hubs, wherein each of the at least two hubs includes a primary key, a stamp indicating the loading time of the primary key in the hub, and a record source indicating the source of the primary key;
at least two satellites, wherein each of the at least two satellites is coupled to at least one of the at least two hubs in a parent-child relationship, further wherein each satellite includes a stamp indicating the loading time of data in the satellite and a business function;
a link to provide a one-to-many relationship between two of the at least two hubs; and
a detail table coupled to at least one of the at least two hubs, wherein the detail table includes attributes of the data from the functional areas of the enterprise.

37. A system as claimed in claim 36, wherein each of the at least two satellites further includes at least one of a primary key, business data, aggregation data, user data, a stamp indicating the time of at least one of user data insertion and user data alteration, and a record source.

38. A system as claimed in claim 36, further comprising a second satellite coupled to at least one of the at least two hubs in a parent-child relationship.

39. A system as claimed in claim 36, wherein the link includes at least two foreign keys and a stamp.

40. A system as claimed in claim 36, wherein each of the at least two hubs further includes an associated business key and a stamp includes indicating the loading time of the associated business key.
